(19) United States
(12) Patent Application Publication
(10) Pub. No.: US 2016/0322175 A1
(43) Pub. Date: Nov. 3, 2016

(54) HIGH POWER RELAY

(71) Applicant: ZETTLER Electronics GmbH, Puchheim (DE)

(72) Inventors: Richard Bayer, Puchheim (DE); Sven Assmus, Teltow (DE)

(21) Appl. No.: 15/208,918

(22) Filed: Jul. 13, 2016

Related U.S. Application Data
(63) Continuation of application No. PCT/EP2015/051023, filed on Jan. 20, 2015.

(30) Foreign Application Priority Data
Jan. 20, 2014 (EP) 14151838.1

(51) Int. Cl. H01H 1/58; H01H 50/64; H01H 50/24

(52) U.S. Cl. CPC H01H 1/5822; H01H 50/24; H01H 50/641

(57) ABSTRACT

A contact arrangement for a relay 1 enables a particularly high maximal current and at the same time safe operation, if it has a base 10 to which a static contact 20 is mounted and if it further comprises a movable contact 30, which is movable between a first position and a second position wherein the movable contact electrically connects the static contact 20 in its first position and wherein the movable contact is disconnected from the static contact in its second position and a stranded wire 35 connecting the second contact with a connection terminal 42 and which mechanically supports the movable contact 30.

### CROSS-REFERENCE TO RELATED APPLICATIONS

This application is a continuation of pending International Application No. PCT/EP2015/051023 filed on 20 Jan. 2015, which designates the United States and claims priority from European Application No. 14151838.1 filed on Jan. 20, 2014. The disclosure of each of the above-identified patent documents is incorporated herein by reference.

### BACKGROUND

1. Field of the Invention

The invention relates to a contact arrangement for a relay configured to switch high currents and a relay with such contact arrangement. The contact arrangement has a base supporting at least one static contact. Further, the contact arrangement has a movable contact, which is movable between at least a first position and a second position, wherein the movable contact contacts the static/fixed contact in the first position to thereby provide an electrically conducting connection between the fixed and movable contacts. In the second position the fixed and movable contacts are separated.

2. Description of Relevant Art

Relays are operated electrical switches and can be used to control an electrical circuit by a low power signal. The controlled electrical signal may, however, be a high power signal.

Laid open German Patent Application DE 10 2008 039 704 A1 discloses a relay with a contact arrangement for switching currents of, e.g., 30 A. The contact arrangement has a first static contact and a second movable contact. The movable contact is mechanically supported by a first end of an elastic plate to which it is connected by riveting. The other end of the elastic plate is mounted to the housing of a coil. When energizing the coil, a movable armature forces the first end of the elastic plate and thus the movable contact to move towards the static contact. The contacts of the relay are closed. When interrupting the control circuit, a spring retracts the movable contact and the contacts are opened. The movable contact is connected via a wire to a connection terminal. The wire is bent to form a loop and to thereby provide a self-supporting structure. The recoil force of the bent wire is absorbed by the movable contact, to which both ends of the wire are connected. A connection terminal is connected to a middle section of the wire. Bending of the wire gives it a stable form to ease mounting the middle section to a connection terminal by welding.

### SUMMARY

The problem to be solved by the invention is to provide a reliable and easy to manufacture relay for switching high currents of, e.g., 200 A or more.

The contact arrangement of the invention comprises at least a preferably non-conducting base, for example a plate of some resin or a molded article. Such base supports at least one static contact, as well referred to as a fixed contact. The static contact may be electrically connected with and/or provide a connection terminal for connecting the contact with a circuit, e.g. via a first cable, or a circuit board. The connection terminal may be and/or comprise at least one connection pin. The contact arrangement further comprises at least one movable contact. The movable contact can be moved at least from a first position to a second position. In the first position, the movable contact connects the static contact electrically; the contacts are closed. In the second position there is an insulating gap between the static contact and the movable contact, to thereby disconnect them; the contacts are open. Accordingly, moving the movable contact from the first to the second position or vice versa is referred to as opening or closing the contacts, respectively. Preferably, the movable contact is mechanically supported by a wire, in particular by a multifilament wire, interchangeably referred to a stranded wire or stranded conductor.

A stranded wire is a conductor composed of a group of wires or of any combination of groups of wires (cf. IEEE Dictionary of Electrical and Electronics Terms, 5th. Ed, IEEE New York, 1993).

Preferably, a support supports the at least one stranded wire and such stranded wire mechanically supports the movable contact and electrically connects the movable contact with a connection terminal (for example, via the support). The support may be mounted to the base. The support may be a beam, profile and/or a conductor bar. The support may comprise at least one connection terminal, e.g. a connection pin, for connecting the movable contact via the stranded wire with a circuit to be controlled by the contact arrangement.

The flexibility of the stranded wire enables the movement of the movable contact. Further, the stranded wire may electrically connect the movable contact with a connection terminal. In contradistinction with related art, the stranded wire is not necessarily bent to form a self-supporting loop, but may be at least approximately straight. Bending of the stranded wire is only required when moving the movable contact from the first to the second position or from the second to the first position, i.e. when opening or closing the contacts. However, to emphasize the difference from the related art, such “bending” results in only a slightly curved stranded wire, as bending forces when moving the movable contact should be as low as possible. Thereby, the recoil force of the stranded wire when moving the movable contact between its positions is reduced, resulting in higher contact forces and faster switching.

Preferably, the movable contact is attached to a free end of the at least one stranded wire. This reduces bending forces when moving the movable contact.

For example, the movable contact can be a conductor bar extending at least essentially or substantially orthogonally to the longitudinal direction of said at least one stranded wire (the term substantially is defined by an optional deviation, from the stated value, of ±30°, preferably ±15°, and more preferably ±5°). The conductor bar may be a pendulum swinging between its first and second positions, if actuated accordingly. Further, multiple stranded wires can be arranged in parallel easily, thereby enhancing the maximal current of the contact arrangement and the mechanical support. Beyond, the degree of freedom of the swinging movement is restricted and the contacts contact each other well defined. Instead of two or more parallel stranded wires a band or belt like stranded wire provides similar advantages. Of course one can as well arrange at least two band belt like stranded wires in parallel.

Preferably, the movable contact comprises at least one recess into which an end of the stranded wire engages. The recess can be, e.g., a through hole or a blind hole. In any case, the stranded wire can be attached and at the same time electrically connected to the movable contact by inserting the stranded wire in said recess very easily, and thus cheap. Fixation of the stranded wire may be obtained by press fitting, welding, soldering, or the like.

The stranded wire may be a multifilament wire of twisted and/or braided filaments. Such stranded wires provide enhanced mechanical properties, i.e. the mechanical support of the movable contact by the stranded wire is enhanced.

The support may be attached to the base and supporting a first end of said at least one stranded wire. The support may be of a conductive material, e.g. of sheet metal or the like and thereby provide not only mechanical support of the stranded wire but as well contact the stranded wire with at least one connection terminal. For example, the support may be a metal profile with a first leg being attached to the base and a second leg supporting said first end of said at least one first stranded wire. In case of a non-conducting support, the stranded wire must be connected by other means with a connection terminal or a wire for providing an electric connection between said movable contact and the electrical circuit to be controlled by the contact arrangement.

The second leg of the profile preferably extends orthogonally to the surface of the static contact to be contacted by the movable contact (or, in a related embodiment, at an angle of 90°±30° with respect to the such surface). This enables a particular simple attachment of the stranded wire ‘above’ the static contact. The movable contact thus has a rest position that is close to at least one of the first or second positions, thereby enhancing opening or closing the contact.

If the support extends through at least one through hole of the base and provides at least one connection terminal and/or connection pin at the side of the base which is opposite to the movable contact, the contact assembly can be manufactured at low price and can be attached to circuit board very easily, e.g. by soldering the connection terminal(s) to the circuit board. Alternatively, a clamping connection be provided by a socket on the circuit boards, but in any case assembly of the electric circuit to be controlled by said contact arrangement is enhanced.

In a similar way, the static contact may have a contact surface for being contacted by the movable contact and extends through at least one through hole of the base to thereby provide at least one connection terminal at the side of the base which is opposite to the movable contact. This connection terminal can be connected like the connection terminal being connected with the movable contact with a circuit board, further enhancing assembly of the electric circuit to be controlled.

At least one of the contact surfaces may be convex. Such contact surfaces can be provided, e.g., by contacting rivets or contacting pins, being attached to at least one of said contacts. Alternatively (or even additionally) a convex contacting surface may be provided by at least one protrusions of the respective contact(s). The contacts may comprise one or more contact surfaces. As well at least one of the contact surfaces may be planar. The form of the contact surfaces depends of the mechanical layout of the contact assembly, the contact surfaces' materials, the application of the contact assembly and other parameters. The best contact surfaces (form and material, e.g. coatings) for a given set of parameters can be determined experimentally.

The contact assembly may as well comprise an actuator for moving the movable contact, thereby rendering the contact assembly into a relay. In other words, the relay has at least one actuator being operably connected to the movable contact for moving the movable contact from the first two the second position and/or from the second to the first position by some actuating means. The actuating means may be a lever, a rod, a rope, a frame or the like.

The actuator may be a solenoid drive with at least one coil and an armature, being attracted by said coil when energized. More precisely the attraction is due to the magnetic field generated by energizing said coil and may be the result of a reluctance force. A core may be positioned in the coil. The magnetic flux may be guided using at least one joke, and the armature may be attracted to the joke and/or the core when the coil is energized to generate said magnetic field.

The actuator and the movable contact may be mechanically coupled by some actuating means, e.g. at least one push-pull rod or the like. Preferably, the actuating means is driven by the actuator. In other words, the relay has at least one actuator or actuating means that is operably connected to the movable contact for moving the movable contact from the first to the second position and/or from the second to the first position.

Preferably, an actuating means drive is attached via at least one hinge to the movable contact. The hinge decouples the rotation of the swinging movable contact from the movement of the actuating means, and thereby enhances the electrical contact when closing the contacts. Beyond, tensions in the actuation means are reduced.

Preferably, the actuating means is supported by an armature of a solenoid drive or the leg of the armature via a first hinge and by the movable contact via a second hinge, wherein the leg of the armature swings at least essentially parallel (that is parallel within the tolerance of ±15°, preferably ±10°, and even more preferably within the tolerance of ±5°) to the at least the section of the stranded wire being close to the movable contact. Thereby the actuating means, so to speak swings in parallel when the opening or closing the contact. The force of the solenoid drive is provided effectively to the movable contact without negatively affecting the movement of the movable contact. The contact force can thus be enhanced.

While at least one stranded wire would be enough to mechanically support and electrically connect the movable contact, the presence of two or more stranded wires helps to avoid a twisting or tumbling motion of the movable contact and enhance the maximal current of the contact arrangement. The same effects can be obtained with a stranded wire in the form of a belt, i.e. with a wire having a rectangular or racetrack-like cross-section.

### BRIEF DESCRIPTION OF THE DRAWINGS

In the following, the invention will be described by way of example, without limitation of the general inventive concept, on examples of embodiment and with reference to the drawings.

FIG. 1 shows a section view of a first relay with closed contacts,

FIG. 2 shows a section view of the first relay with open contacts, and

FIG. 3 shows a front view of the first relay.

FIG. 4 shows a section view of a second relay with closed contacts,

FIG. 5 shows a section view of the second relay with open contacts, and

FIG. 6 shows a front view of the second relay.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

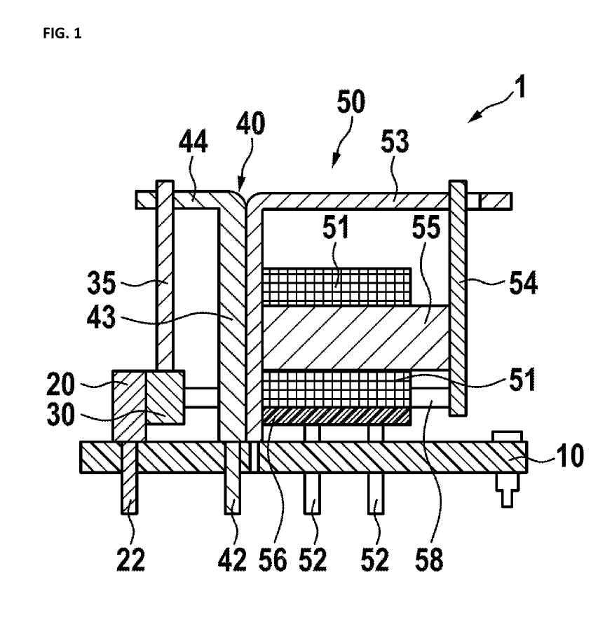

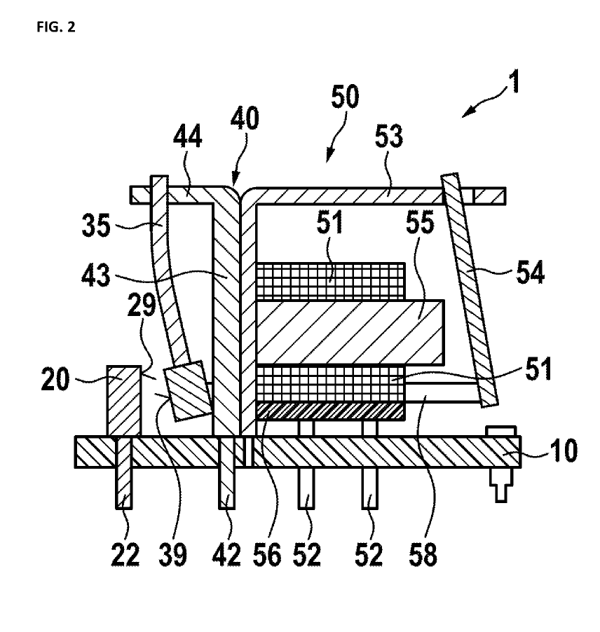

In FIGS. 1 to 3 a first embodiment according to the invention is shown. The relay 1 has a base 10. A static contact 20 is mounted to the base, by inserting pins, forming connection terminals 22, into complementary recesses of the base. Thus, the connection terminals 22 extend through the base and have the form of connection pins. The static contact 20 has a contact surface 29 (with such label appearing only in FIG. 2) to be contacted by a movable contact 30 with a complementary contact surface 39 (see FIG. 2).

In this particular example, the contact surfaces 29, 39 are shown to be planar. The contact surfaces 29, 39 providing the electrical connection of the contacts 20, 30 when closed may be convex as well. In other words, the contacts 20, 30 may each have at least one convex contact surface. For example, the static contact 20 and/or the movable contact 30 may comprise at least one protrusion (e.g. two or more protrusions) with a convex surface which connects with the respective complementary contact surface of the respective other contact 20, 30. As well, only one contact of contacts 20, 20 may have at least one convex contact surface configured to contact a planar or a concave surface of the other contact 20, 30.

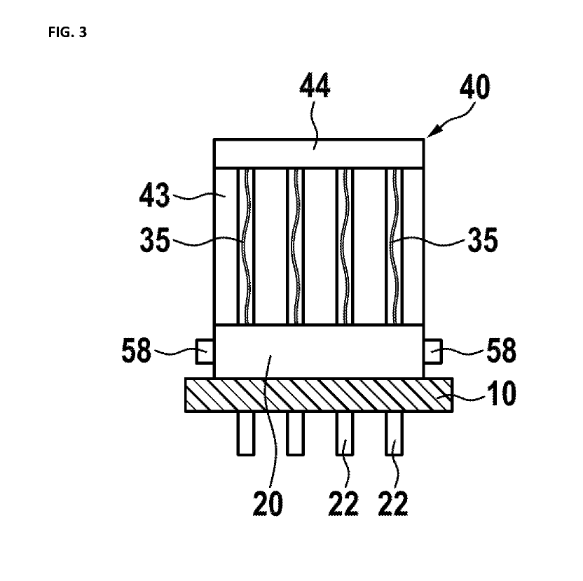

The movable contact 30 is a connector bar being movably supported and electrically connected by at least one stranded wire 35 (as example, four stranded wires 35 are depicted, c.f. FIG. 3). The stranded wires 35 are attached to a support 40. Attaching and contacting the at least one stranded wire 35 to the support is obtained by soldering. Other techniques like brazing or welding may be used alternatively. As well, the at least one stranded wire 35 may be inserted into a recess of the support and attached by press fitting. The support is of a conducting material. In the depicted embodiment, the support 40 is a profile made of sheet metal with a first leg 43 and a second leg 44.

The first leg 43 is attached to the base 10 and has pins extending through the base and which may be used as connection terminal 42 and have the form of connection pins. The second leg 44 is at the distal side of the first leg 43, i.e. the side facing away from the base 10 and forms angle of approximately 90° (the exact angle may be within a range of 90°±15°, preferably a range of 90°±10°, even more preferably a range of 90°±5°) with respect to the first leg 43. Thus, with respect to the base, the second leg 44 is at least approximately parallel to the base 10. The movable contact 30 swings like a pendulum below the support 40.

A solenoid drive 50 is mounted to the base 10 and may be coupled with the movable contact 30 for moving the movable contact 30 between a first position where it contacts the static contact 20 (see FIG. 1), the so called closed position, and a position where the two contacts are separated, the second or open position, as shown in FIG. 2.

The solenoid drive 50 has a yoke 53, which may be attached directly to the base 10. The yoke 53 is connected to the core 55 of a coil 51 to guide the magnetic field of the coil 51 via an armature 54 to the opposite side of the coil 51. The armature is pivotably supported, e.g. by said yoke 53 and swings parallel to the movable contact 30. The armature 54 and the movable contact 30 are coupled by actuating means 58, here as example in the form of a push-pull rod. The actuating means 58 are be attached to the armature 54 and the movable contact 30 by at least one hinge.

The armature 54 is spring loaded towards its open position (FIG. 2; for simplicity, the spring is not shown). Thus, when energizing the coil 51, the armature 54 is attracted towards the core 55 and thus the coil 51 and thereby pushes the movable contact 30 against the static contact 20. The contacts 20, 30 are thus closed. When switching the coil 51 off, the spring actuates the armature 58 and thus as well the movable contact 30 back into the open position, as they are coupled by said actuating means 58 as explained above. Thus, the relay's contacts are of normally open type, but the scope of the invention is of course not limited to normal open type contacts. By a simple rotation of the fixed and movable contacts 20, 30 around a vertical axis the contacts (20, 30) would be normally closed, i.e. the contacts would be disconnected when energizing the coil. Alternatively, a different actuator could be used instead of the depicted solenoid drive 50.

As can be best seen in FIG. 3, the movable contact is supported by four (or another number of, generally at least one) stranded wires 35 and so to speak hangs down from the support 40. Attaching and contacting the at least one stranded wire 35 is obtained by soldering (brazing or welding may be used as well). As well, the at least one stranded wire 35 may be inserted into a recess of the movable contact and attached by press fitting. The actuation means 58 are attached to the left and/or right narrow side of the movable contact, preferably by a hinge. The other end of the actuation means 58 are be attached similarly to the armature (cf. FIG. 1 and FIG. 2).

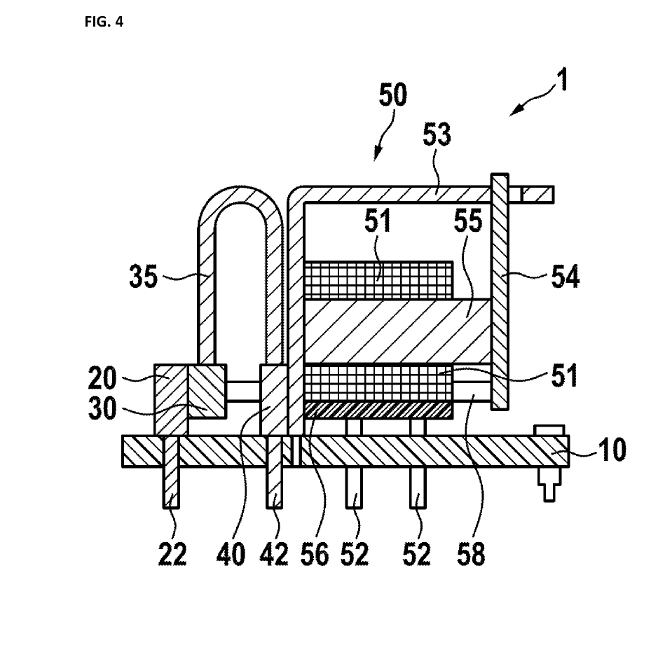

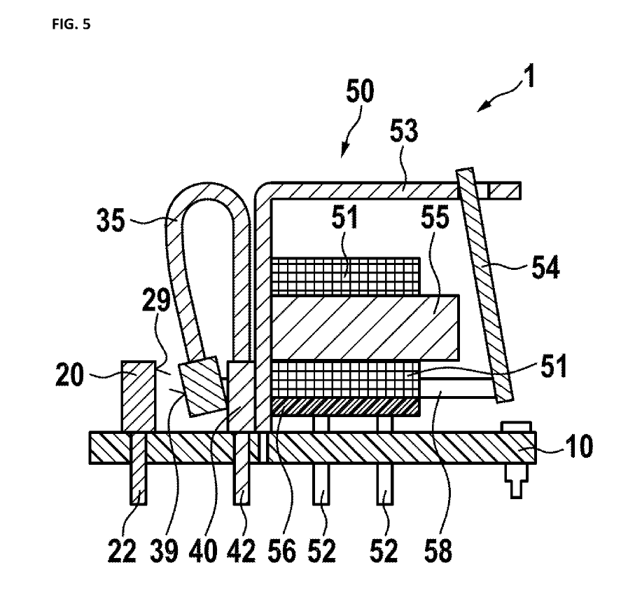

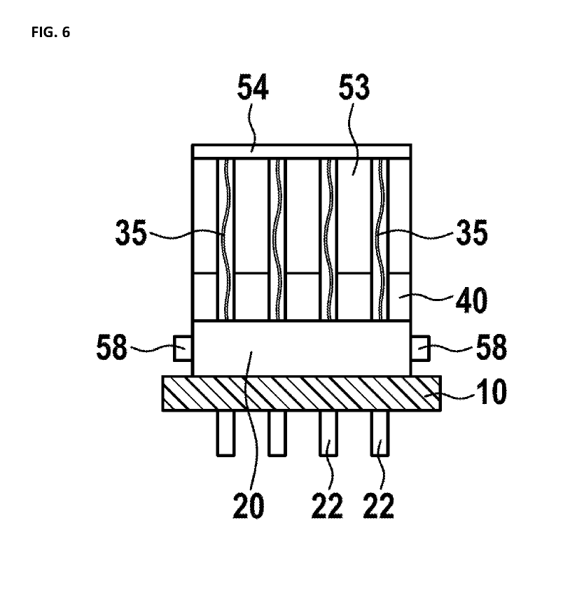

The second implementation of a relay 1 (as shown in FIG. 4, FIG. 5, and FIG. 6) is very similar to the implementation of a first relay 1 (as shown in FIG. 1, FIG. 2, and FIG. 3) and comprises, in a fashion similar to that illustrated in FIG. 1 to FIG. 3, a base 10 that supports a solenoid drive and a static contact 20. These parts are essentially the same, and the same reference numerals are used for the details. So far the description provided in reference to FIG. 1, FIG. 2, and FIG. 3 can be applied to FIGS. 4, 5, and 6 as well. Only the mechanical support of the movable contact 30 differs slightly: specifically, s support 40 has pins 42 extending through the base 10. Differently from the version support of FIG. 1, FIG. 2, and FIG. 3, the version of support shown in FIGS. 4, 5, and 6 is a conductor bar. In the top side of the conductor bar are recesses into which first ends of stranded wires 35 engage (the recesses are in not in the intersection plane). The stranded wires 35 have a first straight section extending substantially vertically (or, within the range of ±15° with respect to a vertical line, preferably within the range of ±10°, even more preferably within the range of ±5°) out of the support 40. Above the first section, the stranded wires 35 have a bent second section forming a curve of at least approximately 180° (±25°, preferably ±10°, even more preferably ±5°). A third section hangs down from the curved second section. The free end of the third sections of the at least one stranded wire 35 engage into recesses of a movable contact 30 and are fixed therein. The movable contact 30 so to speak hangs at the free end of at least one stranded wire 35 havening the form of an inverted U. The contact surface 39 of the movable contact 30 is at least approximately at the same height of the complementary contact surface 29 of the static contact 20. The stranded wires 35 thus electrically connect and mechanically support the movable contact. The movable contact 30 is connected by actuating means 58 to the armature 54 of the solenoid drive 50. The armature 54 is supported to swing in parallel with the movable contact 30.

In the examples, four stranded wires 35 are shown (see FIGS. 3 and 6), but the scope of the invention is not limited by such number. Again, it is pointed out, with respect to both examples, that at least one stranded wire would be enough, but two or more stranded wires can be advantageously used to reduce a twisting or tumbling motion of the movable contact 30 and enhance the maximal current of the contact arrangement. As explained above, the same effects can be obtained with at least one stranded wire in the form of a band or belt, i.e. with a rectangular or racetrack like cross section.

Only for simplicity of illustration, the relays described in reference to the Figures and in the Summary section are shown to have only one static contact 20 and only one movable contact 30. However, other numbers of static or movable contacts 20, 30 can be realized as well. For example, a second static contact may be provided opposite the first static contact, to be contacted if the movable contact is in its second position and to be disconnected from the movable contact 30 when the movable contact 30 connects the first static contact 20. Further, two static contacts 20 may be positioned side by side and/or a movable contact 30 is provided at both sides of the static contact(s).

It will be appreciated to those skilled in the art having the benefit of this disclosure that this invention is believed to provide an enhanced relay. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 relay
10 base
20 static contact
22 connection terminal
29 contact surface
30 movable contact
35 stranded wire
39 contact surface
40 support
42 connection terminal
43 first leg
44 second leg
50 solenoid drive
51 coil
52 connection terminal
53 yoke
54 armature
55 core
56 solenoid support
58 actuating means (here as example a push-pull rod)

1. A contact arrangement for a high-current relay, said arrangement comprising at least
a base supporting a static contact,
a movable contact configured to be movable between a first position and a second position, wherein the movable contact electrically connects the static contact in the first position and wherein the movable contact is disconnected from the static contact in the second position, and
at least one stranded wire electrically connecting the movable contact with at least one connection terminal, wherein the at least one stranded wire mechanically supports the movable contact.

2. A contact arrangement of claim 1, wherein
the movable contact is attached to a free end of said at least one stranded wire.

3. A contact arrangement of claim 1, wherein
the movable contact is a rod extending substantially orthogonally with respect to the longitudinal direction of said at least one stranded wire.

4. A contact arrangement of claim 1, wherein
the movable contact comprises at least one recess into which an end of the stranded wire engages.

5. A contact arrangement of claim 1, wherein
the stranded wire is a multifilament wire constructed from filaments that are configured as at least one of twisted and braided filaments.

6. A contact arrangement of claims 1, wherein
a support is attached to the base, supporting a first end of said at least one stranded wire.

7. A contact arrangement of claim 1, wherein
the support is a profile with a first leg attached to the base and a second leg supporting a first end of said at least one stranded wire.

8. A contact arrangement of claim 7, wherein
said second leg of the profile extends substantially orthogonally to a surface of the static contact that, in operation, is contacted by the movable contact.

9. A contact arrangement of claim 6, wherein
the support extends through at least one through hole of the base to provide at least one connection terminal at a side of the base that is opposite to the movable contact.

10. A contact arrangement of claim 1, wherein
the static contact has a contact surface configured to be contacted, in operation of the of the contact arrangement, by the movable contact, said static contact extending through at least one through hole of the base to provide at least one connection terminal at a side of the base that is opposite to the movable contact.

11. A contact arrangement of claim 1, wherein
at least one of the static contact and the movable contact comprises a contact surface that is in contact with a contact of another of the at least one of the static and movable contacts when the movable contact is in its first position, said contact surface being a convex surface or a planar surface.

12. A relay with the contact arrangement of claim 1, wherein
the relay has at least one actuator operably connected to the movable contact and configured to effectuate at least one of the following: a) moving the movable contact from the first position to the second position; b) moving the movable contact from the second position to the first position; and c) moving the movable contact from the first position to the second position and from the second to the first position.

13. The relay of claim 12, wherein
a linear drive is attached via at least one hinge to the movable contact.
